(19) United States
(12) Patent Application Publication
(10) Pub. No.: US 2008/0109794 A1
(43) Pub. Date: May 8, 2008

(54) Method for Signaling Runtime Events to an Automated Test Script

(75) Inventors: Cheryl S. Adams, Sunnyvale, CA (US); Victor L. Havin, Mountain View, CA (US); Bruce A. Malasky, Kailua Kona, HI (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/557,167

(22) Filed: Nov. 7, 2006

(51) Int. Cl. G06F 11/36

(52) U.S. Cl. 717/130

(57) ABSTRACT

An embodiment of the present invention relates to using a test script to test a program under test (PUT) based on instrumenting the program under test by inserting state inspection code into predefined points of interest associated with test initialization points, test start points, and test completion points. A test script is modified to listen for notifications from the instrumented program under test. When an instrumented process is being executed notification is sent to a runtime library (RTL). The runtime library then delivers the notification by way of inter-process communication (IPC) to the test script. The test script uses such notifications, in part, to determine states of the program under test and to test the program under test.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to using a test script to test a program under test (PUT) based on instrumenting the program under test by inserting state inspection code into predefined points of interest associated with test initialization points, test start points, and test completion points. In particular, a test script is modified to listen for notifications from the instrumented program under test. When an instrumented process is being executed notification is sent to a runtime library (RTL). The runtime library then delivers the notification by way of inter-process communication (IPC) to the test script. The test script uses such notifications, in part, to determine states of the program under test and to test the program under test.

2. Description of Background

Before our invention automated user interface (UI) software testing tools often relied on a state change in one of the graphical user interface (GUI) components to detect the internal state of a computer program under test. Such internal state changes can give insight to the tester and test tools as to the operational condition and testing outcome of the software under test.

However, in many testing situations, there may be no clear manifestation of such a state change and as such automated UI testing can struggle to provide accurate and reliable feedback and or know precisely when to start and stop testing of certain features and or processes. In addition, without state changes to provide feedback there may be times when the testing tools are unsure even what code is currently running much less if it has passed or failed testing.

In cases where a state change cannot be relied upon for feedback many software testing tools implement arbitrary delays into the test to allow a process in the software under test to finish or arrive at what is hoped to be a known point in the software under test or in the testing tool itself before calling a test finished and or before starting the next testing step. These arbitrary delays are mostly just a guess and often can be too long causing testing in general to take longer then necessary, or too short which can cause all sort of testing issues as the software under test may not be ready to start the next process and as a result the test fails or subsequent tests fail to start.

To exacerbate the problem of arbitrary delays, in software under test, there can be processes that take a varying amount of time and as such the process appears to run and be completed at varying speeds. In these cases arbitrary delays to wait for processes to finish won't work because the process duration takes varying amounts of time. As an example, a process that must access remote data processing resources, or wait for a system to initialize or reset may take seconds, minutes, or hours to complete.

As such relying on arbitrary delays or pre-calculated timeout periods to get around the problem of not having state changes to rely on for feedback during testing and to better synchronize the starting and stopping of testing activities can render a test and or test tools inefficient and unreliable, and in general can negatively impact the ability of the test tools to properly test the software under test.

### SUMMARY OF THE INVENTION

The shortcomings of the prior art are overcome and additional advantages are provided through the provision of a method of signaling runtime events to an automated test script, the method comprising instrumenting a program under test (PUT) by adding code at a plurality of points of interest; acquiring references to a runtime library in the plurality of points of interest; modifying a test script to listen for notifications from the program under test; modifying the launching procedure to cause the program under test to run; sending notification from the program under test to the runtime library when one of the plurality of points of interest is executed; and signaling runtime events using inter-process communications (IPC) to send notifications from the runtime library to the test script.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution, which combines code probe insertion with inter-process communications (IPC) and automated test scripting to achieve test events notification.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a test system diagram;

FIG. 2A illustrates one example of sample code class MyProgram listing without probe instrumentation;

FIG. 2B illustrates one example of sample code with a probe that instruments init( ), and doProcessing( ); and

FIG. 3 illustrates one example of a testing routine 1000.

The detailed description explains the preferred embodiments of the invention, together with advantages and features, by way of example with reference to the drawings.

### DETAILED DESCRIPTION OF THE INVENTION

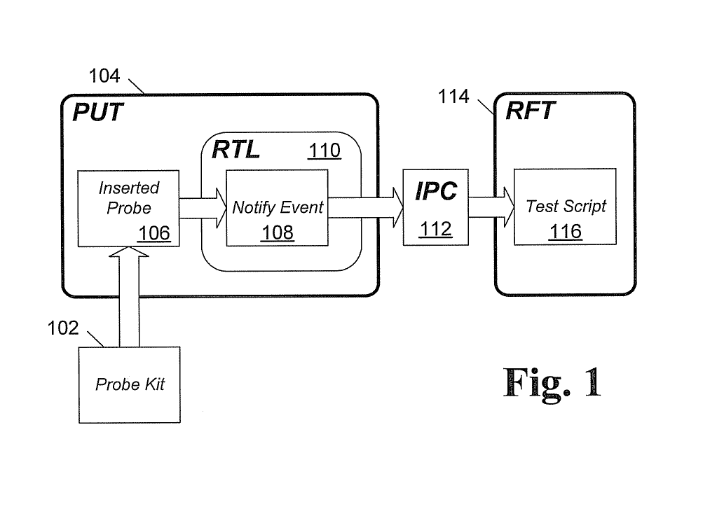

Turning now to the drawings in greater detail, it will be seen that in FIG. 1 there is one example of a test system diagram. In this regard, a probe kit (PK) 102 is used to insert probe code shown as inserted probe 106, in a program under test (PUT) 104. During testing the inserted probe 106 when executed generates a notify event 108. The notify event 108 code is associated with the runtime library (RTL) 110. A notification is sent as an inter-process communication (IPC) 112 to a test script 116. The test script 116 is associated with a rational function tester (RFT) 114. The program under test (PUT) 104 can be software, firmware, and or other types and kind of instruction based and or computer executable code. The program under test (PUT) 104 can also be referred to as code, and or test software. A probe kit 102 is one example of and can be referred to as a code instrumentation engine. As such a code instrumentation engine can be used to insert notifications. An RFT 114 is one example of and can be referred to as an automated test system.

In an exemplary embodiment the test system can effectuate the ability to combine probe insertion with inter-process communications, and automated test scripting to achieve test event notification. Furthermore, such test system implementation can eliminate usage of arbitrary delays and timeouts in test scripts. Removing delays in testing not only speeds testing but also can make the test more reliable as the delay guesswork is eliminated. As such, overall test reliability is improved, and such a testing strategy gives rise to a more universal way in which to monitor the program under test (PUT) states.

To contrast, some prior art approaches to program testing use methods for detecting a change of state in a program under test. In this regard, they run the program in the debug mode and use the debugger breakpoints to signal a state change.

In an exemplary embodiment of the present invention, the approach is much less intrusive and more flexible, and a debugger to detect and signal a state change is not needed. In one example Java Bytecode instrumentation is employed, and state changes are signaled by the code inserted by the instrumentation engine. In this regard, there aren't any requirements imposed on the execution environment. That is a debugger does not need to be installed, and debug information is not required to effectuate testing of the program under test. Moreover, with the approach of this embodiment of the invention the program under test may be debugged if necessary without interfering with the state monitoring subsystem.

To contrast further, some prior art approaches seek to integrate automated testing with software development. In this regard, special purpose libraries are used and the approach requires the software developer to implement the source code with special test related objects embedded in the code and linked to the library.

In an exemplary embodiment of the present invention the approach to program testing is based on the dynamic or static code instrumentation and therefore doesn't require any modifications in the program source. Moreover, any pre-existing code can be tested without changing the source code.

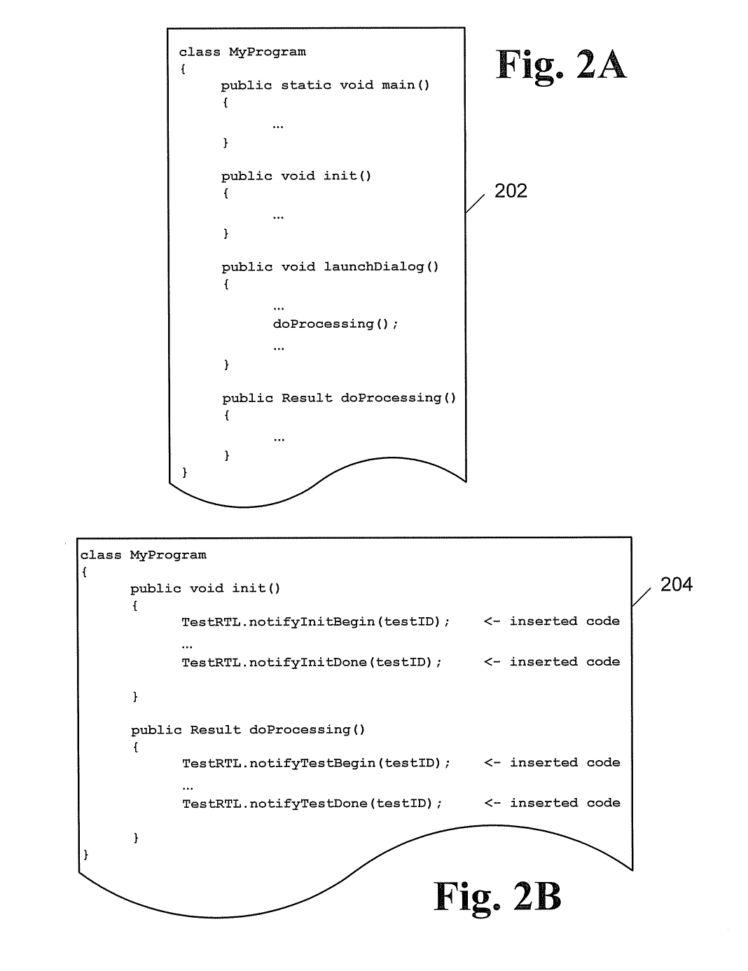

Referring to FIG. 2A there is illustrated one example of sample code class MyProgram listing 202 without probe instrumentation. As an example, in an exemplary embodiment if you want to automate testing of class MyProgram sample code 202 the rational function tester (RFT) or other scriptable test engine initiates a test by starting MyProgram and then generating a UI event that will result in calling MyProgram.launchDiaolog( ). In this illustration assume that the test is considered done when the process doProcessing returns. The doProcessing( ) process doesn't necessarily trigger any UI events, but may run anywhere from a few seconds to a few hours. As such, the ending of the test cannot be precisely determined.

In contrast, referring to FIG. 2B there is illustrated one example of sample code with a probe that instruments init( ), and doProcessing( ). In this exemplary embodiment of the invention, the test engineer implements a probe that instruments processes init( ) and doProcessing( ). In an exemplary embodiment, the instrumented code will look like what is illustrated in FIG. 2B.

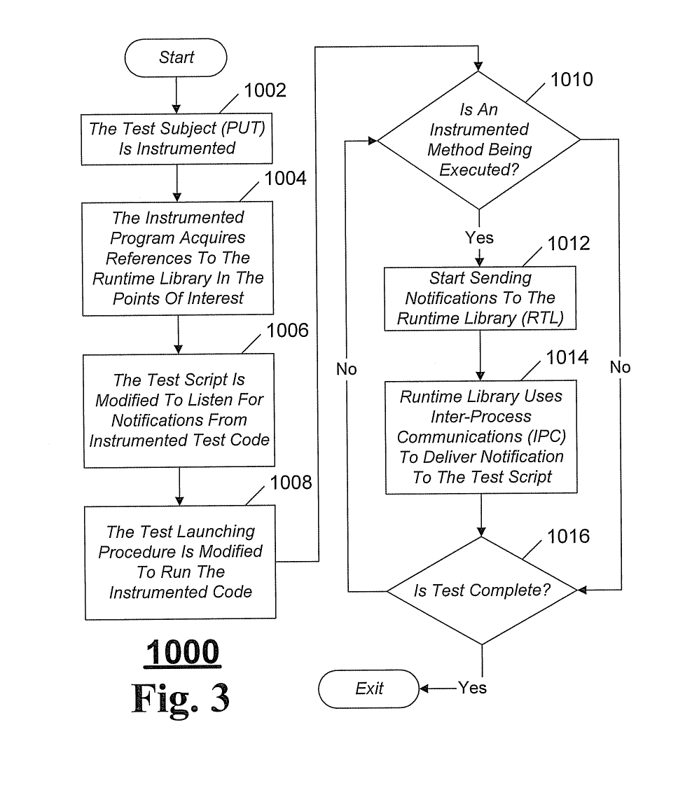

When executed the probe code TestRTL.notifyInitBegin(testID), TestRTL.notifyInitDonen(testID), TestRTL.notifyTestBegin(testID), TestRTL.notifyTestDone(testID) provide precise notification through IPC 112 to the test script 116 as to the status of the beginning and end of a particular test. One method of performing such testing with the insertion of probe code is illustrated in FIG. 3.

Referring to FIG. 3 there is illustrated one example of a testing routine 1000. The method is based on instrumenting the test subject (program under test (PUT)) by inserting the state inspection code into the predefined points associated with test initialization, test start, and test completion. In an exemplary embodiment, the code insertion is rendered with BCI technology developed by IBM. The method is not limited by the automatic user interface (UI) testing and can be used in any testing environment where it is hard to detect test completion. In addition, the test instrumentation may be performed statically or dynamically. Processing begins in block 1002.

In block 1002 the program under test (PUT) is instrumented by the probe kit (PK) 102. In this regard, the program under test has state inspection code inserted into predefined point of interest associated with test initialization points, test start points, and test completion points. Processing then moves to block 1004.

In block 1004 the instrumented program acquires references to the runtime library in the points of interest. Such points of interest can include for example and not limitation, test initialization, test start, and test completion. In an exemplary embodiment, the test engineer defines these points of interest. Processing then moves to block 1006.

In block 1006 the test script is modified to listen for notification from the instrumented test code. In an exemplary embodiment for example and not limitation, the script modification is not an automatic process. Although it may be modified programmatically in some cases, in general it is the test developer responsibility to extend the test script with the notifications' processing code. Processing then moves to block 1008.

In block 1008 the test launching procedure is modified to make it run the instrumented code. Processing then moves to decision block 1010.

In decision block 1010 a determination is made as to whether or not an instrumented method is being executed. If the resultant is in the affirmative that is an instrumented method is being executed then processing moves to block 1012. If the resultant is in the negative that is an instrumented method is not being executed then processing moves to decision block 1016.

In block 1012 when an instrumented method is being executed it starts sending notification to the runtime library (RTL). Processing then moves to block 1014.

In block 1014 the runtime library uses inter-process communications (IPC) to deliver these notifications to the test script 116. Processing then moves to decision block 1016.

In decision block 1016 a determination is made as to whether or not the test is complete. If the determination is in the affirmative that is the test is complete then the routine is exited. If the resultant is in the negative that is the test is not complete then processing returns to decision block 1010.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of signaling runtime events to an automated test script, said method comprising:
instrumenting a program under test (PUT) by adding code at a plurality of points of interest;
acquiring references to a runtime library in said plurality of points of interest;
modifying a test script to listen for notifications from said program under test;
modifying the launching procedure to cause said program under test to run;
sending notification from said program under test to said runtime library when one of said plurality of points of interest is executed; and
signaling runtime events using inter-process communications (IPC) to send notifications from said runtime library to said test script.

2. The method in accordance with claim 1, wherein instrumenting a program under test includes instrumenting said program under test by inserting a plurality of state inspection code into said plurality of points of interest.

3. The method is accordance with claim 2, wherein said plurality of points of interest include test initialization points, test start points, and test completion points.

4. The method is accordance with claim 3, wherein said test script is part of an automated test system.

5. The method in accordance with claim 4, wherein instrumenting a program under test includes using a code instrumentation engine.

6. The method in accordance with claim, 5 wherein said test script does not contain any delays and or pre-calculated timeouts.

7. The method in accordance with claim 6 wherein, said points of interest are determined by a test engineer.

8. The method is accordance with claim 7, wherein said program under test is firmware.

9. The method in accordance with claim 8, wherein said probe kit is an IBM BCI probe kit.

10. The method in accordance with claim 9, wherein said method does not make use of a debugger.

11. The method is accordance with claim 7, wherein said program under test is a Java program.

12. The method in accordance with claim 11, wherein said probe kit is an IBM BCI probe kit.

13. The method in accordance with claim 12, wherein said method does not make use of a debugger.

14. The method is accordance with claim 4, wherein said automated test system is a rational functional tester (RFT).

15. The method in accordance with claim 5, wherein said code instrumentation engine is a probe kit (PK).
